(19) United States
(12) Patent Application Publication
(10) Pub. No.: US 2008/0190961 A1
(43) Pub. Date: Aug. 14, 2008

(54) METERED DOSING CONTAINER WITH INDEPENDENTLY DEFORMABLE INTERNAL BLADDER

(75) Inventors: Daniel M. Wyner, North Scituate, RI (US); Roger J. LaFlamme, Enfield, CT (US); Richard B. Fox, Smithfield, RI (US); Robert J. Mileti, Torrington, CT (US)

Correspondence Address: BARLOW, JOSEPHS & HOLMES, LTD., 101 DYER STREET, 5TH FLOOR, PROVIDENCE, RI, 02903, US

(73) Assignee: POLY-D, LLC, Torrington, CT (US)

(21) Appl. No.: 12/026,829

(22) Filed: Feb. 6, 2008

Related U.S. Application Data
(60) Provisional application No. 60/889,218, filed on Feb. 9, 2007.

(51) Int. Cl. B65D 35/56; B67D 5/06; B65D 37/00

(52) U.S. Cl. 222/207; 222/105; 222/183

(57) ABSTRACT

The present invention is a fluid dispensing device that includes a reusable outer housing that defines a bladder-receiving region. An independently deformable bladder, that contains media to be dispensed therein, resides in the bladder-receiving region. A pump, which is accessible from the outside of the housing by a user, is installed in fluid communication with the bladder to dispense media from the bladder for use. When media is depleted from the bladder, the bladder and pump arrangement can be easily replaced with a full bladder and new pump for installation into the reusable outer housing.

### CROSS-REFERENCE TO RELATED APPLICATIONS

This application claims priority from prior U.S. Provisional Application Ser. No. 60/889,218 filed on Feb. 9, 2007.

### BACKGROUND OF THE INVENTION

This invention relates generally to dispensing devices and packages. More specifically, the present invention relates to metering devices that can controllably dispense fluid media from a source of fluid media while providing an overall package configuration that remains substantially the same throughout the life of the use of the container even though the volume of the supply of media to be dispensed is being depleted.

Various types of fluid material and media are employed for different purposes through commerce and industry. For example, there are various products in the personal care, home care, air care, transportation care, and food industries that require some type of dispensing of a fluid material from a source of such material. When this material is sold in commerce, it must be contained and stored in some type of container. When that product is used, it must be dispensed from its storage container to a location for use.

In the prior art, there are many different types of dispensers for delivering fluid material. For example, a flexible container body with a nozzle tip is commonly provided for such a purpose. An application of such use is for the dispensing of ketchup where the container body is squeezed by the user to urge the fluid material out from the nozzle tip and accurately to a desired location. The amount of fluid delivered is determined by the how much the user squeezed the container body. However, this yields erratic results where more or less fluid material is delivered on each successive squeeze of the container body. Also, the container must be held upright to avoid leakage because no valves are employed. Therefore, there is a need for a dispensing package that can deliver the media contained therein a controlled and metered fashion.

To meet this need, a flexible container holds a volume of fluid material to be delivered. A single one-way check valve is provided as an exit port from the flexible container. When the flexible body is squeezed, the material is urged out under pressure through the valve. In commonly owned Ser. No. 11/074,817, filed on Mar. 8, 2005, and U.S. Ser. No. 11/951,351, filed on Dec. 6, 2007 a dual valve construction is employed to provide for controlled metered dispensing of media from a package. However, these known devices require that the entire package be disposed of when the supply of media to be dispensed has been depleted.

In the prior art, there are durable containers such as liquid soap dispensers available now that contain a rigid plastic pumping mechanism as part of the container. The exterior of these types of containers can be made to have a pleasing appearance out of crystal or metal. These products do not work well for a variety of reasons. For one thing, they do not fully dispense the liquid soap, but usually cease to pump as the liquid soap level gets low. Secondly, they require the user to fill the container with liquid when it gets low. This is inconvenient. Thirdly, the user has no real method of knowing when the container is getting low on fluid. Finally, the pumping mechanism is built into the outside container, and when it breaks, the container is no longer useful.

In view of the foregoing, the fluid dispensing and devices of the prior art suffer from various disadvantages that make them difficult and awkward to use with unexpected results. Therefore, there is a need for a fluid dispenser to be easy to operate. There is a further need for a fluid dispenser to be capable of delivering a metered dose of fluid upon each dispensing operation for expected flow for better application of the fluid material. There is also a need for such a dispenser to be less wasteful than prior art dispensers.

### SUMMARY OF THE INVENTION

The present invention preserves the advantages of prior art dispensing devices. In addition, it provides new advantages not found in currently available devices and overcomes many disadvantages of such currently available devices.

The invention is generally directed to a novel and unique dispenser for delivering a substantially equal metered dose of media fluid material upon each dispensing operation while not requiring that the entire dispenser be replaced when the media is depleted.

The fluid dispensing device includes a container with an independently deformable bladder therein. The bladder includes a pump and dispensing system that can deliver the media in a dosed and metered fashion. The container provides a outer exoskeleton that is preferably rigid but may also be semi-rigid to receive the internal dispensing bladder. When the internal bladder is depleted of media for dispensing, it may be simply removed and replaced with a new bladder while leaving the outer rigid exoskeleton container housing for re-use. This substantially saves on cost in that the outer housing need not be replaced entirely each time when the supply bladder is empty. The internal bladder and outer housing may be in any form or configuration to suit the dispensing application at hand.

As far a metered dispensing, the pump and valve configuration may be of any form. It is preferred that a flexible metering housing be disposed in fluid communication with the fluid storage region of the internal bladder with a first one-way valve disposed between the container and the flexible metering housing. One way flow from the interior fluid storage region of the container fills the predetermined volume of the metering chamber with fluid by vacuum action when the flexible metering housing is depressed and then released. A second valve is in fluid communication with the metering housing output port and permits one-way fluid flow from the metering chamber to the exterior outer region of the container to a desired position when the metering housing is depressed again. Each time the metering housing is depressed a substantially equal volume of fluid is dispensed from the container. Optionally, an additional applicator layer on the outside of container, such as foam, facilitates dispersion and delivery of the fluid.

The internal deformable bladder of the present invention may reside in the outer exoskeleton housing in many different ways with the pump dispensing mechanism exposed for manipulation by a user. For example, it may snap into the housing where the door of the housing secures the internal bladder in place during the use. The door may be easily opened to remove the bladder when it is empty and replace it with a new full bladder.

It is therefore an object of the present invention to provide a fluid dispensing device that can deliver a substantially equal volume of fluid material from each dispensing operation.

It is an object of the present invention to provide a fluid dispensing device that is includes a independently deformable bladder.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a front perspective view of a metering dispensing device of the present invention with an outer housing with a full internal deformable bladder residing therein;

FIG. 2 is a front perspective view of a metering dispensing device of the present invention with an outer housing with an empty internal deformable bladder residing therein;

FIG. 3 is a perspective view of the present invention integrated into a three dimensional container shown in a full state;

FIG. 4 is a perspective view of the present invention integrated into a three dimensional container shown in an empty state;

FIG. 5 is a cross-section view through the line 5-5 of FIG. 3;

FIG. 6 is a cross-sectional view of a metering dispensing pump mechanism that can be employed to pull media from an internal deformable of the present invention;

FIG. 7 is a front perspective view of another embodiment of the bladder and pump construction in accordance with the present invention;

FIG. 8 is a cross-sectional view through the line 8-8 of FIG. 7; and

FIG. 9 is a cross-sectional view through the line 8-8 of FIG. 7 showing the pump and bladder in the process of dispensing fluid.

### DETAILED DESCRIPTION OF THE PREFERRED EMBODIMENT

In general, the novel features of the present invention relate to a metered dosing/dispensing container wherein there is an outer shape and an inner bladder, and where the inner bladder can contract independently of the outer container housing. Optionally, the inner bladder can replaced, when empty, independently of the outer housing. The outer housing can be rigid or semi-rigid, allowing it to maintain a form independent or partially independent from the shape of the inner bladder configuration.

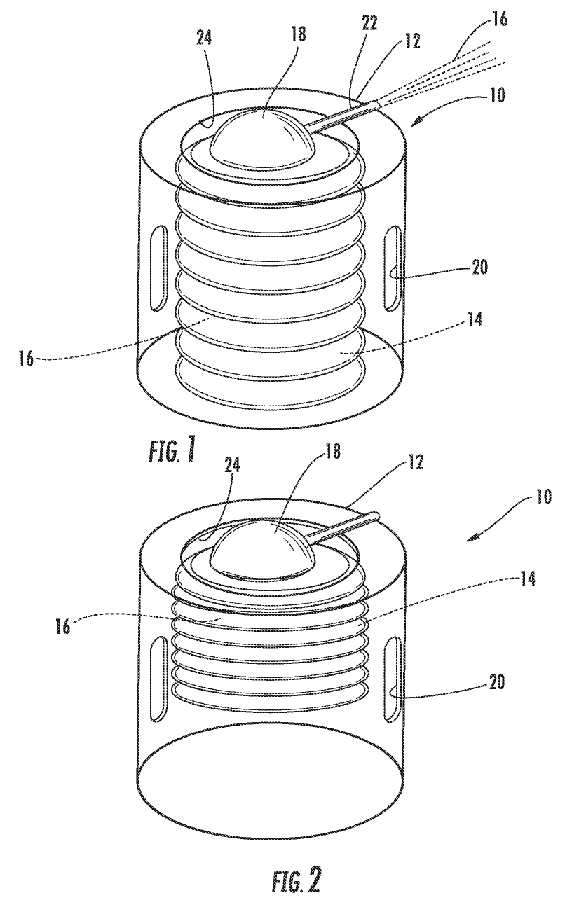

Referring first to FIGS. 1 and 2, the present invention provides a metered dispensing container 10 with an exoskeleton 12 formed from either rigid semi-rigid materials which provide for the visible shape and configuration of the overall container to the user. Within the exoskeleton 12, a flexible bladder 14 is provided that contains the fluid 16 to be dispensed. Integrated into the exoskeleton 12 or, more preferably, the bladder 14 is a metered pumping dispensing system 18 as described in the previously referred to commonly owned application, as will be described below in connection with FIGS. 6-9 below.

The internal bladder 14 is designed so as to be able to move independently from the outer housing exoskeleton 12. As liquid 16 is dispensed through the metering pump 18, the internal bladder 14 reduces in volume within the housing exoskeleton 12. The housing exoskeleton 12 preferably remains in a static shape and configuration, namely, the same shape and configuration as when originally purchased. Alternatively, its shape can independently change overall or in specific areas.

In the present invention, the internal bladder 14 can be constructed to specifically allow for expansion in a number of ways. In one embodiment of the invention, the internal bladder 14 is formed from an elastic or balloon like material which expands when filled, but contracts when empty. The elasticity of the bladder 14 system can actually assist in the pumping of the liquid 16. In another embodiment of the invention, the bladder 14 can be surrounded wholly or partially with an elastic material providing for the contraction. In such an embodiment, the internal bladder 14 can be elastic or non-elastic, with the elasticity of the external wrapping of the bladder 14 providing for additional force in contracting the shape of the bladder 14.

In still another embodiment of the invention, the bladder 14 can be designed with pleats or other folded geometries allowing for it to expand and contract in a predetermined geometry. An example of such an embodiment would be a bladder 14 formed in an accordion or bellows-like structure allowing for the bladder 14 to expand or contract in length, as seen in FIGS. 1 and 2. An accordion or otherwise pleated bladder can contract into a very small shape when evacuated, but expand into a cylindrical or rectangular shape as the accordion structure expands. FIGS. 1 and 2 show such an internal bladder 14 with a metering device 18 with a bladder 14 that has been formed in a bellows or accordion shape.

In accordance with the present invention, the bladder 14 could be of any shape to provide an aesthetically pleasing appearance whether in a full condition, empty condition or any condition therebetween. In such a case, the exoskeleton can be transparent, translucent or opaque with windows, as discussed below, to enhance the visual appeal of the product. The bladder 14 itself can be a configuration that contracts in the X, Y or Z direction or any combination thereof. For example, the bladder may be a pleated balloon that collapses in the X, Y and Z directions at the same time to provide a unique visual effect as the media is depleted from the dispenser over time. It is also possible that the bladder 14 twists or rotates as it is depleted of dispensed media.

In FIG. 1, the bellows-shaped bladder 14 is mostly filled with fluid media 16 to be dispensed while FIG. 2 shows the internal bladder 14 in a partially empty state. When fully emptied, the bellows-shaped bladder 14 could conceivably be designed to be very compact. For example, as the bladder 14 is emptied, it can deflate and collapse to a much smaller size.

The rigid or semi-rigid housing exoskeleton 12 could be designed to have openings or holes 20 of any kind to serve as a window to allow visibility of the internal bladder structure 14. In FIGS. 1 and 2, the openings 20 are shown as small windows or holes, but the housing exoskeleton 12 could be fabricated to be mostly open space, with very little structure, or could be a compete cover with no openings.

In FIGS. 1 and 2, the metered dispensing pump 18 is shown in a top mounted position, with an adjacent exit port 22 to dispense liquid 16. An aperture 24 in the housing exoskeleton 12 is provided to permit the pump mechanism 18 to be exposed so a user may have access thereto for manipulation thereof to carry out the desired metered pumping and dispensing action. In some applications this may be desirable, but the metered dosing pump 18 and exit port 22 could be located anywhere on the dispenser 10 in accordance with the application at hand.

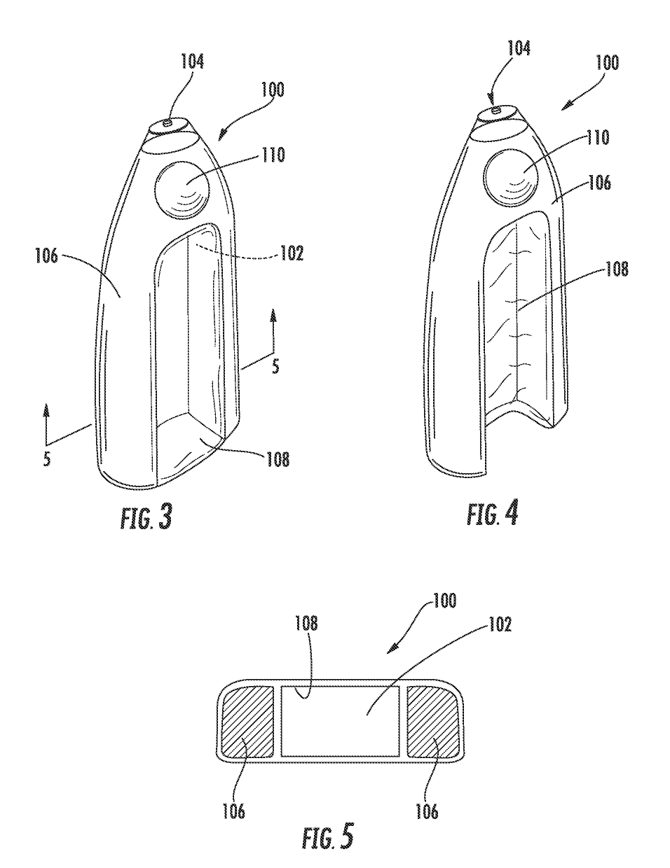

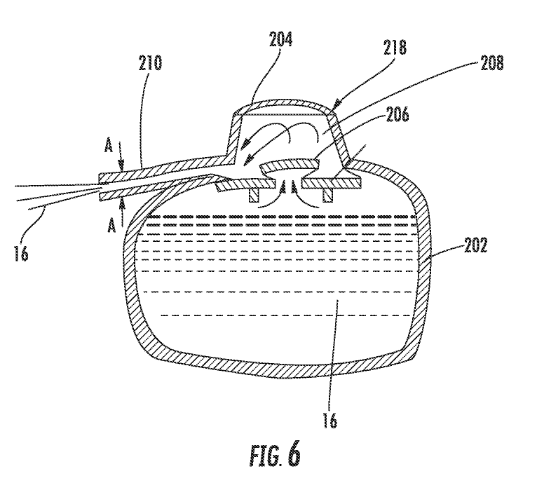

For example, as in FIGS. 3-5, if the dispenser 100 is for dispensing shampoo 102, it would be desirable to have the liquid shampoo exit at the top of the dispenser 100 via exit port 104. In this upright container example, an outer exoskeleton 106 contains and provides support for a bladder 108 that contains liquid 102, such as shampoo. Metering dispensing pump 110 resides between and is in fluid communication between the bladder 108 and the exit port 104. FIG. 3 shows the bladder 108 substantially full of liquid 102. When the pump 110 is actuated, it draws liquid 102 from the bladder 108 to dispense it through exit port 104 for use. FIG. 4 shows the bladder 108 in a substantially empty state as virtually all of the liquid 102 has been dispensed. It should be particularly noted that the shampoo container 100 remains upright and still substantially in its original shape and configuration even though the bladder 108 has been emptied.

The embodiments of FIGS. 1-5 are examples of how the bladder 14, 108 of the present invention can be used to dispense media 16, 102 when installed in a housing exoskeleton 12, 106. More specifically, the accordion or bellows shape shown in FIGS. 1 and 2 is not the only type of expanding geometry or structure that can be used for the present invention. Other pleated or folded geometries can be used as well, depending upon the desired filled and emptied shapes of the bladder 14.

For ease of discussion, the construction of the bladder 14 will be discussed in detail in connection with the embodiment of FIGS. 1-2. However, it should be understood that the bladder 108 of the embodiment of FIGS. 3-5 may be made in the same way. The bladder 14 can be formed from bonding two sheets of thermoplastic films into a flat shape or a fixed geometry such as a rectangle or any other outlined form, and the expansion and contraction can take place within that welded flat shape. In such a case, the bladder 14 will expand or contract by becoming thicker or thinner, but the basic 2-dimensinal outline shape of the sealed bladder 14 will remain the same.

Alternatively, the inner bladder 14 can be constructed into a simple shape, but be made with sidewalls so it has some three dimensional geometry. An example of a rectangular bladder with sidewalls can be seen in FIGS. 3-5. In this embodiment 100, as above, the container of the present invention is in the form of a bottle that has an internal yet visible rectangular-shaped bladder 108 that contains the liquid 102 to be dispensed. Surrounding the rectangular bottle is a semi-rigid foamed exoskeleton 106 providing for a stand-up structure and aesthetics. As the internal liquid 102 is dispensed using the metered dosing pump 110, the rectangular bladder 102 collapses gradually. FIG. 4 shows the container in an empty condition. In general, the bladder 14, 108 can be either respectively integrated into the exoskeleton 12, 106 or separable so that it can be easily replaced, as discussed above. Because one surface of the rectangular bladder 108 is visible to the user, the volume of remaining fluid 102 can be judged. Essentially, the housing exoskeleton 106, in this example, has one large cut-way to serve as a window to view the bladder 108. Because the system is preferably vacuum driven, most or all of the internal liquid 102 can be dispensed without having to turn the bottle 100 in an alternate orientation.

FIGS. 6 shows a first embodiment of a mechanism that can be used a metering dispensing pump, referred to as 218 for dispensing the liquid 16. Bladder 202 contains liquid 16. When released, a flexible dome 204 pulls liquid 16 upwardly through first valve 206 to fill metering chamber 208. When the dome 204 is depressed, the first valve closes and liquid 16 is urged out through exit port 210. The exit port 210 acts as a second valve and, when liquid is not being pumped, the distance A is substantially reduced so that opposing sides of the exit port seal the dispenser to prevent accident dispensing. When dispensing is desired, the dome 204 is pressed and liquid 16 is urged out through the exit port 210 to expand it temporarily to permit outflow of liquid 16, as desired.

Another embodiment of the metering dispensing pump is shown in FIGS. 7-9. In FIG. 7, a perspective view of a metering dispenser 300 that employs the improved valving in accordance with the present invention. An outer storage bladder 320 is provided that may be formed of two sheets of material 304, 306 secured together, such as by welding, or a tube of material. A metering pump, generally referred to as 326, pulls liquid 302 from the bladder 320, meters it, and then dispenses it via an exit port 308.

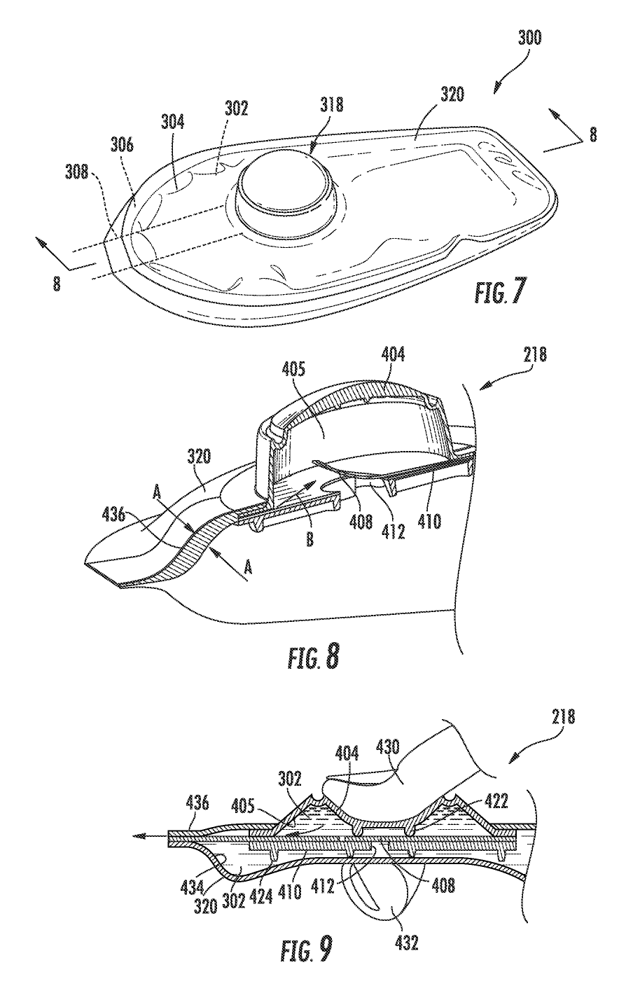

Referring to FIGS. 8 and 9, the dispending of liquid 302 is shown. When it is desired to actually dispense the liquid product 302, the user's thumb 430 can depress the flexible dome 404 and the user's index finger 432 can invert the base plate 410 from convex to concave, by application of force against the stand-off legs 424, such that flexible dome 404, with the assistance of the stand-off legs 422 under the flexible dome, securely seals and provides a positive lock of the flapper valve 408 over and about the aperture 412 thereby closing the liquid flow passage back into the reservoir 434 of the storage container 320. It is also possible that the base plate 410 is concave and then is inverted to a convex configuration. Other fingers of the user may be used to carry out this operation. Thus, the only path for the liquid 302 contained within the cavity 405 of dome 404 is to exit through the one-way outlet valve 436 for intended dispensing of the product, as indicated by the arrows in FIG. 14.

It should be understood that the stand-off legs 422 on the bottom of the flexible dome housing 404 and the stand-off legs 424 on the bottom of the base plate 410 can be modified in size, length and configuration to adjust the amount of squeezing necessary by the user's fingers 430, 432 to effectuate sealing of the flapper valve 408. For example, preferably four stand-off legs 422 are provided on the bottom of the flexible dome housing 404 in a 2×2 array and can be 1/32 of an inch in length. It is also possible that these stand-off legs 422 can be a single downwardly depending wall, such as in the shape of a circle or square. Such an array is configured to downwardly press against the one-way flapper valve 408 outside of the diameter of the aperture 412 through the base plate 410 to provide a good seal of the flapper valve 408 to the base plate 410.

FIG. 8 illustrates further structure to prevent unwanted dispensing of liquid. In addition to the improved valving, as above, automatic shut-off of the exit port passageway 436, when pressure is exerted on the exterior of the storage container 320, serves to prevent leakage. In FIG. 8, when pressured is applied to the outside of the storage container or pouch 320, as indicated by arrows referenced A, the exit port passageway 436 tends to collapse, flatten and squeeze closed. As a result, any material residing in the passageway is urged back into the cavity 405 of the flexible dome housing 404, as indicated by arrow referenced B. As a result, unwanted leakage is prevented when accidental or unintentional pressure is placed on the storage container 320.

The embodiment shown in FIG. 6 is generally shown as a vertically oriented bladder and pump construction while the construction 300 in FIGS. 7-9 shows a lateral design which may be more suitable in certain dispensing environments. The design in FIGS. 7-9 also show a certain configuration of the metering capability of a pump using in the present invention.

It can be easily seen how this basic concept can be used to improve many products. The housing exoskeleton can be designed to provide many features including aesthetics and graphics, stand-up structure, hanging or positioning or attachments features etc. Since the housing exoskeleton remains upright, assembled and in its form as originally purchased, the outer appearance of the product will not degrade over time as the media therein is depleted. Also, an indicia thereon, such as product information and logos can remain prominently displayed throughout the life of the product.

In all of the above embodiments, the bladder 14, 108 is able to expand and contract independently from the exoskeleton 12, 106 of the container, and the exoskeleton 12, 106 provides for external shape or appearance. The exoskeleton 12, 106 of the container 10, 100 can be constructed from any materials that are commonly used for this purpose, including plastic such as polypropylenes, polyethylenes, polyesters, ABS, polystyrene, vinyl, metal, wood, rubber, or any other suitable material. It can also be made of more expensive durable materials such as glass, crystal, gold, silver or other metals, wood, epoxies or other materials that can be crafted into desirable shapes.

Referring back to FIGS. 1 and 2, as to use of windows through the housing exoskeleton 12 to view the bladder 14, it is envisioned that the exoskeleton 12 of the container 10 may have apertures 20 or openings that allow the user to see through the exoskeleton 12 into the internal bladder 14, or may even be made of a very fine structure where most of the bladder 14 is openly visible. In other embodiments, the exoskeleton 12 may be made of fully transparent or partially transparent materials allowing the user to see the state of the inner bladder 14. In still other embodiments of the invention, the exoskeleton 12 may be completely opaque or partially opaque. In cases where the exoskeleton 12 is opaque and the user cannot see the internal bladder 14 it may be beneficial to have a visual indicator or gauge visible on the exoskeleton 12 that can show the approximate level of fluid 16 remaining in the internal bladder 14 or the size of the internal bladder 14.

The inner bladder 14 and dosing pump 18 are preferably designed to be easily removable or replaceable, so that the exoskeleton 14 can be refilled on an ongoing basis, as needed. The exoskeleton 14 can be made using injection molding, blow molding, casting, milling, or any other forming or fabrication techniques, and can be made from both solid materials or foamed materials or combinations thereof. A door or other containment structure is preferably used to retain the internal bladder 14 in place in the housing exoskeleton 12 during use.

More specifically, it is envisioned that the internal bladder 14 system with metered dosing pump 18 may be removable and replaceable within the same exoskeleton 12 so that the housing exoskeleton 12 can be re-used. In cases where the exoskeleton 12 is made from more expensive or higher-grade materials, this may be highly desirable. It may also be desirable, for ecological reasons, to have the bladder 14 and pump component 18 replaceable even when the exoskeleton is made from relatively less expensive materials. In such cases, the internal bladder 14 will take up less packaging and shipping materials, and can be easily made to be fully recyclable. The user can purchase a completely sealed inner bladder 14 with metered dosing pump component 18 in the form of a cartridge-like unit, and replace the unit within the exoskeleton 12 when the bladder 14 is empty. The fact that the exoskeleton 12 could be made from higher end materials such as glass or crystal or gold etc, would allow for the user to have much more attractive containers with easily refillable internal components.

Still further, it is possible, for example, that the exoskeleton 12 could be formed from glass or crystal allowing for a highly decorative container with the inner bladder being replaceable or refillable. Even in cases where the exoskeleton 12 is made from less expensive materials, it may still be desirable to allow for replacement or refilling of the internal bladder 14 and pump component 18 as a unit, as this method of packaging liquids may be more environmentally friendly than current methods, since the exoskeleton 12 shape will be retained and not sent to a landfill.

It is also possible, although not preferred, to provide a housing exoskeleton 12 and pump mechanism 18 that are permanently attached to one another where the bladder 14 alone is replaced when empty. In this example, the bladder 14 is received in the exoskeleton housing 12 for interface by the pump for dispensing, such as by piercing and the like.

The present invention addresses the concerns found in the prior art. It can dispense almost all of the liquid 16 in the bladder 14, since it functions by vacuum because it preferably uses its owns. The user can conveniently refill the unit, by simply dropping is a pre-packaged filled bladder 14. It can be designed to allow the user to see the level of fluid 16 remaining through transparency or openings in the exoskeleton 12. Finally, the metered dosing pump 18 can be part of the bladder assembly 14 itself, so it gets replaced with each refill of the product.

In still other embodiments of the invention, the exoskeleton 12 is preferably made from semi-rigid material such as a foamed plastic or a laminate of plastic films or foams. In such cases, the exoskeleton 12 still provides sufficient structure to maintain its shape despite the change in shape of the internal bladder 14. The exoskeleton 12 can be designed to change shape as well, but the internal bladder 14 is free to move either completely independently or partially independently of the external shape.

As can be seen from the several embodiments enumerated above, the present invention can be used in a variety of configurations. In many cases it would be constructed as a single use disposable consumer package, but in other cases it could be a refillable product with either a low end or high end exoskeleton package that it could be placed into.

There are numerous advantages to the present invention over prior art. The present invention may be more environmentally friendly allowing for the user to maintain the external structure while replacing the internal bladder only. Another advantage is that in the present invention the user may be able to see specifically the quantity of fluid left in the dispensing device, since the bladder 14 may be visible through openings 20 or the transparency of the exoskeleton 12. In addition, in cases where the bladder 14 is made from an elastic material or surrounded by an elastic material, the force of the contracting elasticity on the bladder assist in the evacuation of the liquid in the pumping process. Additionally, the present invention allows for a constant pleasing shape of the external container 10 as the inner chamber is evacuated, but does allow for full evacuation of the internal liquids 16. By allowing the independent movement of the internal bladder 14 in the meter dosing devise, the overall shape of the device 10 does not have to change as the liquid 16 is depleted. The present invention also allows for a package 10 wherein most or all of the fluid 16 can be effectively pumped from the container without changing the orientation.

Still further, a more abrasive material can be provided on one side of the device 10 for more aggressive cleaning, for example, while the opposing side has a polishing type surface.

In summary, a new and novel dispenser with an independently deformable internal bladder 14 is provided that can deliver consistent metered dosages of such fluid 16 media material while being replaceable when empty.

It would be appreciated by those skilled in the art that various changes and modifications can be made to the illustrated embodiments without departing from the spirit of the present invention. All such modifications and changes are intended to be covered by the appended claims.

What is claimed is:

1. A fluid dispensing device, comprising:
housing defining a bladder-receiving region;
a bladder residing in the bladder-receiving region; media to be dispensed residing in the bladder;
a pump in fluid communication with the bladder; the pump configured and arranged to dispense media from the bladder for use.

2. The fluid dispensing device of claim 1, wherein the housing further defines at least one aperture therethrough to enable the bladder to be viewed.

3. The fluid dispensing device of claim 1, further comprising:
means for retaining the bladder in the bladder-receiving region.

4. The fluid dispensing device of claim 1, wherein the bladder has a bellows configuration.

5. The fluid dispensing device of claim 1, wherein the pump is a metering pump.

6. The fluid dispensing device of claim 1, wherein the housing is rigid.

7. The fluid dispensing device of claim 1, wherein the housing is semi-rigid.

8. The fluid dispensing device of claim 1, wherein the pump and bladder are permanently connected to one another.

9. The fluid dispensing device of claim 1, wherein the fluid dispensing device has an outer appearance that remains substantially unchanged during dispensing of media from the bladder during use.
